(19) United States
(12) Patent Application Publication
(10) Pub. No.: US 2017/0057852 A1
(43) Pub. Date: Mar. 2, 2017

(54) A BIOFILTRATION SYSTEM

(71) Applicant: Stellenbosch University, Stellenbosch, Western Cape Province (ZA)

(72) Inventors: Thomas Eugene CLOETE, Somerset West (ZA); Danielle Marguerite DU PLESSIS, Stellenbosch (ZA); Marelize BOTES, Stellenbosch (ZA)

(21) Appl. No.: 15/118,832

(22) PCT Filed: Feb. 13, 2015
(86) PCT No.: PCT/IB2015/051081

§ 371 Date: Aug. 12, 2016

(30) Foreign Application Priority Data
Feb. 13, 2014 (ZA) 2014/01101

(51) Int. Cl. C02F 3/04; C02F 1/38; C02F 3/30; C02F 3/00; C02F 3/10

(52) U.S. Cl. CPC C02F 3/043; C02F 3/006; C02F 3/108; C02F 3/101; C02F 3/109; C02F 3/303; C02F 1/385; C02F 2101/101

(57) ABSTRACT

A biofiltration system for filtering wastewater includes a tower containing a packed bed on which biofilm is able to form and an air inlet below the packed bed and an air outlet above the packed bed. A water feed above the packed bed disperses wastewater over the packed bed. The biofilm serves as a biological contact reactor removing organic and/or inorganic contaminants from the water. Following filtration of the water through the packed bed, filtered water and solid waste sloughed off from the packed bed collects in a sump below the packed bed. Water flows from a water outlet in the sump to a centrifugal separator that separates solid material from water drawn from the sump to expel a waste stream and a filtered water stream.

### CROSS-REFERENCE(S) TO RELATED APPLICATIONS

This application claims priority to South African provisional patent application number 2014/01101 filed on 13 Feb. 2014, which is incorporated by reference herein.

### FIELD OF THE INVENTION

This invention relates to a water filtration system used to purify contaminated water and more specifically to a biofiltration system.

### BACKGROUND TO THE INVENTION

Packed beds are typically used to facilitate liquid/gas interaction and are usually provided by a porous bed of material housed within a vessel. The material is often referred to as packing material or fill material and may be small objects such as rocks, Raschig rings, or the like. In some cases the bed of material may be a specifically designed structured packing such as an arrangement of corrugated sheets.

Packed beds improve contact between two phases in a chemical or similar process by providing a large contact area (being the surface area of the bed of material). Thus, packed beds generally include a gaseous outlet and a liquid inlet above the bed of material and a gaseous inlet and a liquid outlet below the bed of material. A liquid may then pass slowly from the liquid inlet, through the bed of material, to the liquid outlet. Similarly, a gas may pass in an opposite direction to that of the liquid from the gaseous inlet and come into contact with the liquid.

In this specification, “packed bed” shall have its widest meaning and include any porous bed in which a liquid/gas interface can be created.

One of the many applications of packed beds is in cooling towers. A counterflow cooling tower provides a packed bed as described above. Hot water from a heat exchange process is sprayed over the bed of material from the liquid inlet. At the same time, air flows from the gaseous inlet through the bed of material. In so doing it comes into contact with and cools the water flowing through the packed bed. The air continues to flow up through the packed bed and exits through the air outlet whilst the cooled water typically collects in a sump at the bottom of the vessel below the packed bed and exits through the liquid outlet.

Biofiltration is the filtration of contaminated water using organic material to capture and biologically degrade contaminants. A biofilter comprises inorganic or organic filtering media such as rock, slag, sand, glass beads, peat or wood chips on which a biofilm develops when wastewater flows over the filtering media during use. The biofilm serves as a bioorganic contact reactor and removes organic and inorganic contaminants from the contaminated water. With continued use, the biofilm continuously thickens leading to an accumulation of matter in the filtering media that eventually may clog the filter, thereby reducing the flow of wastewater through the filter. The biofilm may be periodically cleaned from the filtering media using oxidising chemicals or may be washed off using a burst of water or air. This can be a time-consuming process requiring additional labour and creating filter downtime.

### SUMMARY OF THE INVENTION

In accordance with this invention, there is provided a biofiltration system which includes a tower that houses a packed bed on which biofilm is able to form with a water feed above the packed bed and a water outlet in a sump below the packed bed, and an air inlet below the packed bed and an air outlet above the packed bed, characterised in that the system further includes a centrifugal separator which is operable to separate solid material from water drawn from the sump to expel a waste stream and a filtered water stream.

Further features of the invention provide for a pump to circulate water from the sump to the water feed.

Still further features of the invention provide for the centrifugal separator to run continuously; and, for the centrifugal separator to be configured to periodically expel a waste stream.

A further feature of the invention provides for a waste outlet of the centrifugal separator to be fitted with a valve and timer configured to periodically expel the waste stream.

Yet further features of the invention provide for the centrifugal separator to return filtered water to the sump; alternatively for the centrifugal separator to return filtered water to the water feed.

A further feature of the invention provides for the air inlet to be intermediate the packed bed and the sump.

A yet further feature of the invention provides for the water feed above the packed bed to include nozzles or sprayers configured to finely disperse water over the packed bed.

A further feature of the invention provides for the packed bed to comprise a highly porous polypropylene fill media.

Further features of the invention provide for the sump to include a feed water inlet valve configured to periodically feed water to flow into the sump and a filtered water outlet valve configured to periodically allow water to flow out of the sump; for the feed water inlet valve to be controlled by a control unit and level sensor, preferably a float ball level switch; and for the filtered water outlet valve to be controlled by a timer.

In one embodiment of the invention a feed water inlet valve and a filtered water outlet valve are provided along a pipe that connects the sump to the water feed above the packed bed arranged such that both the feed water inlet valve and the filtered water outlet valve are downstream of the centrifugal separator and the feed water inlet valve is downstream of the filtered water outlet valve with the feed water inlet valve and filtered water outlet valve configured to have approximately equal flow rates of water.

The invention also provides a method for filtering wastewater, the method including the steps of creating a biofilm on a packed bed in a tower, finely dispersing wastewater from a water feed over the biofilm; collecting the water in a sump; separating solid material from the water in the sump using a centrifugal separator; expelling a waste stream and a filtered water stream from the centrifugal separator; and circulating water in the sump, optionally together with the filtered water stream from the centrifugal separator, to the water feed.

Further features of the invention provide for the further steps of sensing the level of water in the sump with a level sensor; periodically feeding water into the sump through a feed water inlet valve and controlling the amount of water that is fed into the sump using a solenoid valve and control unit in communication with the level sensor.

Yet further features of the invention provide for the further steps of allowing water to periodically flow out of the sump and controlling the amount of water that flows out of the sump by means of a timer. Alternatively, the method includes steps of continuously feeding water into a pipe that connects the sump to the water feed above the packed bed and continuously allowing water to flow out of the pipe at a similar flow rate, provided that the water flows in and out of the pipe downstream of the centrifugal separator and that the water is fed into the pipe downstream of the valve through which water flows out of the pipe.

### BRIEF DESCRIPTION OF THE DRAWINGS

The invention will now be described, by way of example only, with reference to the accompanying representations in which:

FIG. 1 is a schematic diagram which illustrates a biofiltration system according to a first embodiment of the invention;

FIG. 2 is a schematic diagram which illustrates a biofiltration system according to a second embodiment of the invention;

FIG. 3 is a schematic diagram which illustrates a biofiltration system according to a third embodiment of the invention;

FIG. 4 is a bar chart which illustrates COD for treated and untreated water on each of ten days;

FIG. 5 is a bar chart which illustrates the COD percentage reduction for each of ten days;

FIG. 6 is a line chart which illustrates pH values in treated water versus untreated water;

FIG. 7 is a bar chart which illustrates acid capacity in treated water versus untreated water;

FIG. 8 is a bar chart which illustrates total sulfate in treated versus untreated water;

FIG. 9 is a bar chart which illustrates total phosphate in treated versus untreated water;

FIG. 10 is a bar chart which illustrates total ammonium content of treated versus untreated water;

FIG. 11 is a bar chart which illustrates total nitrite content of treated versus untreated water; and

FIG. 12 is a bar chart which illustrates suspended solids in untreated water, centrifuge effluent and treated water.

### DETAILED DESCRIPTION WITH REFERENCE TO THE DRAWINGS

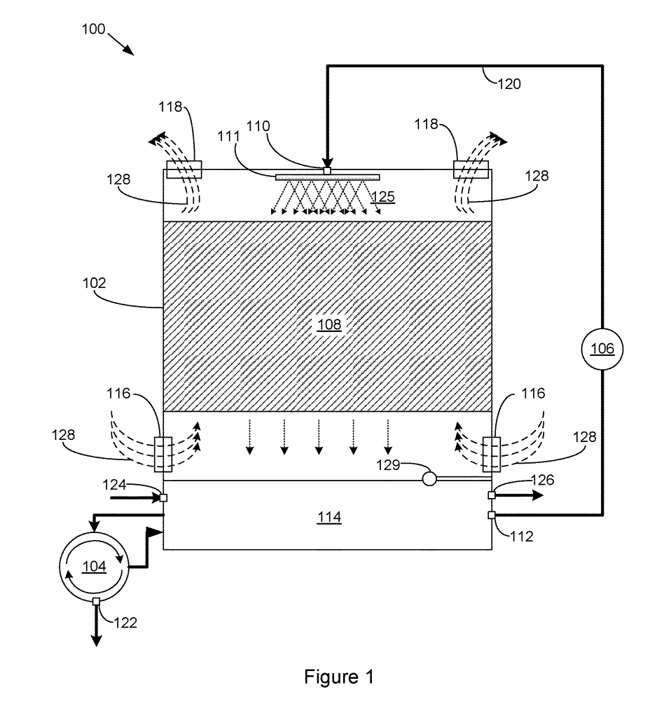

FIG. 1 is a schematic diagram which illustrates a biofiltration system (100) according to a first embodiment of the invention. The water filtration system of this invention is termed a biofiltration system as a biological contact reactor treats water to remove contaminants. The biofiltration system (100) has a tower (102), a centrifugal separator (104) and a pump (106).

The tower (102) is, in this embodiment, a water cooling tower which has a packed bed (108) on which biofilm is able to form and a sump (114) below the bed (108). A water feed (110) is provided above the bed (108) and a water outlet (112) in the sump (114) below the bed (108). Air inlets (116) are provided in the tower (102) intermediate the bed (108) and the sump (114) and air outlets (118) are provided above the bed (108).

In this embodiment the tower is an industrial cooling tower, such as the “ICT 650 small 1500 cooling tower” supplied by Industrial Cooling Towers (Pty) Ltd. However, in other embodiments, large scale cooling towers such as natural draft wet cooling hyperboloid towers typical of power stations may be utilised.

The packed bed (108) includes a highly porous polypropylene fill media in this embodiment. The fill media is a honeycomb matrix incorporating polypropylene sheets with corrugated surfaces. The fill media may be of any type of suitable material and may include any type of matrix, grid, stack of tiles or network of extruded channels that is porous and has a suitably large surface area.

A pipe (120) connects the water outlet (112) to the water feed (110). The pump (106) is fitted inline with the pipe (120) and is operable to pump water through the pipe (120) from the sump (114) to the water feed (110). In this embodiment, the pump (106) is a 0.45 kW swimming pool pump.

The sump (114) also has a feed water inlet valve (124), which is controlled to periodically allow feed water to flow into the sump (114), and a filtered water outlet valve (126) which is controlled to periodically allow water to flow out of the sump (114). The feed water inlet valve (124) is a solenoid valve, in this embodiment, controlled by a level sensor (129). In this embodiment, the level sensor (129) is a float ball level switch. The filtered water outlet valve (126) is a solenoid valve, in this embodiment, controlled by a timer.

The solenoid valves are controllable by an electric current which is supplied to the solenoid, creating a magnetic field and causing the valve to switch from a closed position to an open position or vice versa.

In the case of the filtered water outlet valve (126), the electric current is supplied by the timer after the expiration of a predefined period of time. For example, the timer may be configured to supply an electric current to the solenoid of the filtered water outlet valve (126) after one hour, 10 hours, 24 hours or the like. The timer is further configured to maintain the electric current for a predefined period of time such that all of the water in the sump (114) may exit through the filtered water outlet valve (126) after which the valve is closed. The time period necessary for all the water in the sump to exit through the filtered water outlet can be calculated using the volume of the sump and the flow rate of the water through the filtered water outlet valve.

Similarly, a control unit supplies the electric current to the solenoid of the feed water inlet valve (124) to open the valve. When the water in the sump (114) reaches a predetermined level, the level sensor (129) communicates a control signal to the control unit which causes the control unit to stop supplying current to the solenoid valve. This causes the feed water inlet valve (124) to close once the sump (114) has been filled to a predefined level. In an alternative embodiment of the invention, either one of or both the feed water inlet valve (124) and filtered water outlet valve (126) are electrically actuated ball valves. Other ways to control the feed water inlet valve (124) and the filtered water outlet valve (126) exist.

In this embodiment, the centrifugal separator (104) is operable to separate solid material or sludge from water drawn from the sump (114) to produce a waste stream and a filtered water stream. In this embodiment, the centrifugal separator returns the filtered water stream (which may also be referred to as supernatant) to the sump (114). In other embodiments, the centrifugal separator (104) could, however, return the filtered water to the water feed (110) directly.

The centrifugal separator (104) includes a waste outlet (122) through which solid material or sludge (which may also be referred to as effluent) collected by the centrifugal separator (104) is expelled. Accordingly, the centrifugal separator may also be provided with a timer and solenoid valve. In this embodiment of the invention, the centrifugal separator (104) is a Jumag SCV 1226 D online centrifuge having its own pump to force water through the centrifuge.

In use, the feed water inlet valve (124) is controlled to allow a volume of contaminated water to flow into the sump (114). The contaminated water may for example be municipal wastewater, winery wastewater or the like. The pump (106) pumps water from the sump (114) through the outlet valve (112) and the pipe (120) to the water feed (110).

The water feed (110) includes nozzles or sprayers (111) to finely disperse the water (125) over the bed of material (108). The water slowly flows, or trickles downwards through the packed bed (108) under gravity where it exits and collects in the sump (114). As the water trickles downwards towards the sump (114) it is contacted by air (128) flowing upwards from the air inlets (116) through pores of the bed of material (108) to the air outlets (118).

As the water flows through the packed bed, a biofilm consisting of a mixed population of microorganisms develops on the surface of the material. This biofilm serves as a biological contact reactor, or bioreactor, and a large surface area of biofilm forms which treats the water to remove contaminants therefrom. The biofilm formed on the surface of the packed bed (108) removes organic and inorganic contaminants from the water as it trickles through. Each pass of the water through the bed of material (108) removes some organic and inorganic contaminants contained therein so that passing the water through the bed of material (108), for example a predetermined number of times for a given degree of contamination, removes a sufficient amount of organic and inorganic contaminants for the water to be safe for use. As the thickness of the biofilm increases, oxygen may not penetrate the deepest part of the biofilm closest to the surface of the packed bed. This may create an anaerobic zone for anaerobic decomposition of organics whilst aerobic decomposition occurs in the upper layers of the biofilm.

The pump (106) circulates water through the bed of material (108) and the biofilm may continue to thicken with sustained hydraulic load. As the biofilm gets too thick, it may slough off to produce biological sludge or biomass which collects in the sump (114). The bed of material (108) preferably comprises a porous fill media that is configured to facilitate the detachment and shedding of the biofilm.

The centrifugal separator (104) runs continuously to draw water from the sump (114), remove sediment or sludge, and return the filtered water to the sump (114) or water feed (110) as the case may be. The centrifugal separator (104) is controlled to periodically expel collected sediment through the waste outlet (122). In the illustrated embodiment, the centrifugal separator (104) has a high flow rate and by returning the filtered water stream to the sump (114) at this high flow rate, water turbulence in the sump (114) is created which keeps solid material or sludge in suspension as opposed to allowing it to settle. By keeping the solid material or sludge suspended in the water in the sump, solid material or sludge intake into the centrifuge is greater thus making the extraction of solid material more effective.

After the expiration of a predetermined time period, the water in the sump (114) is removed through the filtered water outlet valve (126).

Thus, the deposition of large volumes of sludge in the sump, a problem associated with existing water cooling tower filtration systems, is alleviated by the inclusion of a centrifugal separator. The centrifugal separator is a compact unit that has been found to be very effective at separating solid material with a higher relative density from the water circulating in the centrifugal separator. It has been found to effectively remove any suspended solid material. This material can be from a variety or origins, for example, from a cellar such as grape remnants and bentonite clay granules, which is a byproduct of wine manufacturing, as well as any sludge or biofilm biomass that detaches from the packed bed within the biofiltration system. Such suspended matter (being solid material or sludge) has small sized particles, and has been found to easily clog any size exclusion filters. The detaching biomass produced when the biofilm reaches maturity and sloughs off, is likely to foul other filters instantly. It has been found that the centrifugal separator, eliminates suspended material without fouling or clogging, and is self-cleaning as it emits the solids by flushing a small volume of water with the solids. The centrifugal separator has been found to be adjustable to emit solids more or less frequently, depending on the amount of solids in the contaminated water. The centrifugal separator is driven only by a small pump, and the release of solids is through a time controlled solenoid valve. It has been found that the small pump and solenoid valve have lower power requirements than many other filters.

Furthermore, by providing a centrifugal separator, solid material or sludge may be separated from water based on relative density. The centrifugal separator emits solid waste, typically along with a small flush of water, meaning that only small volumes of waste are produced and no sedimentation tank is required.

By designing the biofiltration system to have maximal ventilation and a very fine water distribution, a much higher aeration rate is provided than a conventional trickling filter which makes the organic reduction process by the biofilm rapid and effective. Fine water distribution may aid the rapid degradation of organics in the water, reduce the organic load in the water and restore the pH of acidic wastewater to neutral.

Another advantage of the present invention is that a water cooling tower has a much smaller land requirement footprint than a conventional trickling filter. It may be that no, or minimal construction is required as the cooling tower may be pre-fabricated needing only on-site assembly and coupling to a water source and the centrifugal separator. The system requires electricity to run one pump and a solenoid valve and timer on the centrifuge. No additional large pump systems are required and existing infrastructure may be used. On an industrial site requiring water treatment, where cooling towers are already present, one or more cooling towers can be sacrificed to treat water.

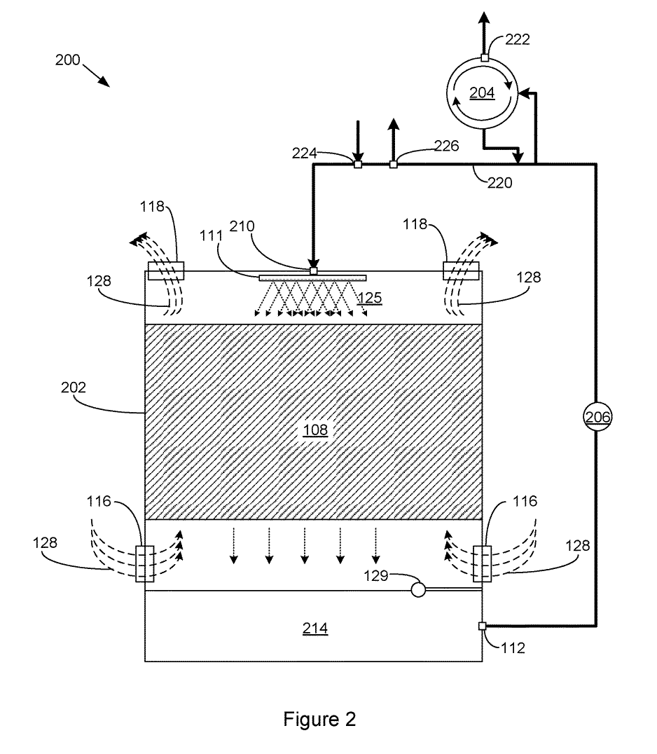

There are numerous variations which may be made to the embodiment of the invention described above without departing from the scope hereof. FIG. 2, for example, is a schematic diagram which illustrates a second embodiment of the biofiltration system (200).

The biofiltration system (200) is similar to that illustrated in FIG. 1 in that it has a tower (202), a centrifugal separator (204) and a pump (206). It differs from the biofiltration system (100) of FIG. 1 in two aspects. Firstly, the centrifugal separator (204) does not draw water from the sump (214), but rather from the pipe (220) as the water flows from the sump (214) to the water feed (210). The centrifugal separator (204) in this configuration may be referred to as a side stream centrifugal separator in that only some of the water flowing in the pipe (220) is drawn from the pipe (220). The centrifugal separator (204) is thus operable to separate solid material or sludge from water drawn from the pipe (220) and to return the filtered water to the pipe (220). The point at which the centrifugal separator (204) draws water from the pipe (220) is upstream from the point at which water is returned to the pipe (220) from the centrifugal separator (204). The centrifugal separator (204) includes a waste outlet (222) through which solid material or sludge collected by the centrifugal separator (204) is expelled.

Secondly, the biofiltration system (200) provides a feed water inlet valve (224) and a filtered water outlet valve (226) along the pipe (220). The feed water inlet valve (224) is downstream of the filtered water outlet valve (226). Both the feed water inlet valve (224) and a filtered water outlet valve (226) are downstream of the centrifugal separator (204). The flow rate of water entering the pipe (220) through the feed water inlet valve (224) is preferably equal to the flow rate of water exiting the pipe (220) through the filtered water outlet valve (226).

In this configuration, the biofiltration system (220) is able to run continuously, with contaminated water being continually input through the feed water inlet valve (224) and filtered water being continually output through the filtered water outlet valve (226).

During start-up, the biofiltration system (200) will typically require the water to be circulated until a sufficient build-up of biofilm occurs. Once the biofilm has built up sufficiently, the biofiltration system (200) may be switched to a continuous mode in which an output occurs as described above.

FIG. 3 is a schematic diagram which illustrates a biofiltration system (300) according to a third embodiment of the invention. The biofiltration system (300) of the third embodiment of the invention is similar to the biofiltration system described above with reference to FIG. 1 and has a tower (302), a centrifugal separator (304) and a pump (306).

The biofiltration system (300) of FIG. 3 differs from the biofiltration system (100) of FIG. 1 in that the centrifugal separator (304) is a mainstream centrifugal separator which is provided inline with the pipe (320). Water pumped through the pipe (320) from water outlet (312) in the sump (314) to the water feed (310) flows through the centrifugal separator (304).

The centrifugal separator (304) is thus operable to separate solid material or sludge from water in the pipe (320) as the water flows through the centrifugal separator (304). Filtered water exits the centrifugal separator (304) and flows through the remainder of the pipe (320) to the water feed (310). The centrifugal separator (304) includes a waste outlet (322) through which solid material or sludge collected by the centrifugal separator (304) is expelled.

In one pilot implementation, a tower, having dimensions 650×650×1500 mm and a sump volume of 80 litres, a 0.45 kW pump, a Jumag SCV 1226 D centrifugal separator and a highly porous polypropylene packed bed were used in a biofiltration system according to embodiments of the invention.

The cycles of the entire system were powered and controlled with an automated time schedule controller unit.

The pilot implementation was used for a ten day period and the water was tested each day. New contaminated water or wastewater was introduced every day and run passed through the biofiltration system for 24 hours after which filtered water was removed. Samples were collected daily from the new input water (untreated water), from the sump (treated water) and from the centrifuge effluent, which was collected and pooled over 24 hours.

The site chosen for the assembly of the pilot scale model was a winery, due to an easily accessible, constant supply of contaminated industrial wastewater or contaminated water, high in organic load and chemical oxygen demand (COD). Winery wastewater served as the model for industrial wastewater in this project. The removal of organic matter and/or contaminants from the water was studied with standard water analysis tests. For the included data, water samples and biofilm samples were collected and analysed daily over a period of 10 days to monitor biofilm development and reduction in organic and/or inorganic contaminants in treated water samples, as well as the parameters of untreated water.

The biofiltration system was set up in close proximity to a well containing contaminated water. Initially, 80 litres of wastewater was introduced to the sump of the cooling tower. Pumps were switched on to start the cycling of the wastewater through the system. The online centrifuge was programmed to dump collected supernatant by expelling 200 mL through the collection area once every 45 minutes. The system treated 200 litres of water over a 24 hour period, with a flow rate of 40 litres per second through the tower.

All water samples were analysed on the following parameters:
COD
pH
Acid capacity
Total sulfate
Total phosphate
Ammonia
Nitrate
Suspended solids

Analyses were performed on the day of sampling. The pH and temperature was measured with a Crison basic 20+ pH-meter. All other tests were performed using Merck Spectroquant spectrophotometry system with specific cell test kits (Merck), measuring sample turbidity with the spectroquant.

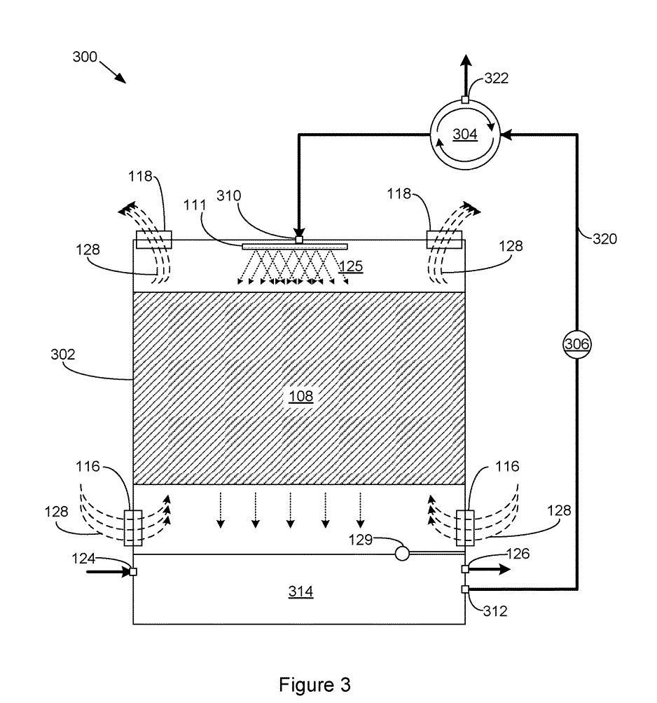

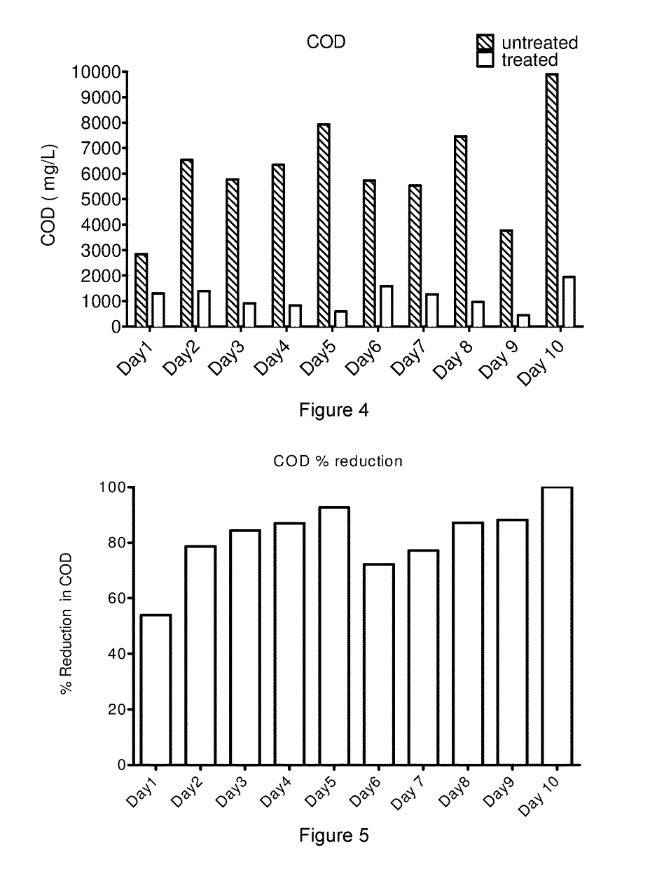

FIG. 4 is a bar chart which illustrates COD (in milligrams per litre) for treated and untreated water on each of the ten days. FIG. 4 shows that the influent water feeding the system varied daily between approximately 3000 and 7000 mg/L due to different activities taking place in the winery during the harvesting period, affecting the effluent water quality.

FIG. 5 is a bar chart which illustrates the COD percentage reduction for each of the ten days. FIG. 5 illustrates that the biofiltration system decreased the COD by 53% during the first day of biofilm development. It was expected that as the biofilm matured, the COD would be reduced by a bigger margin. This was the case for the biofilm of 2, 3, 4 and 5 days of age, with a steady reduction in COD with a reduction of 92% on day 5. On day 6 a lesser reduction in COD was observed, with a reduction of only 72%, despite the COD of the input water being lower. This is an indication that COD of the input water does not directly affect the COD of the treated water. Because the suspended solids in the centrifuge effluent on day 6 was higher than all the preceding days, it can be speculated that the biofilm detached some of its mass, making less biomass available for COD reduction.

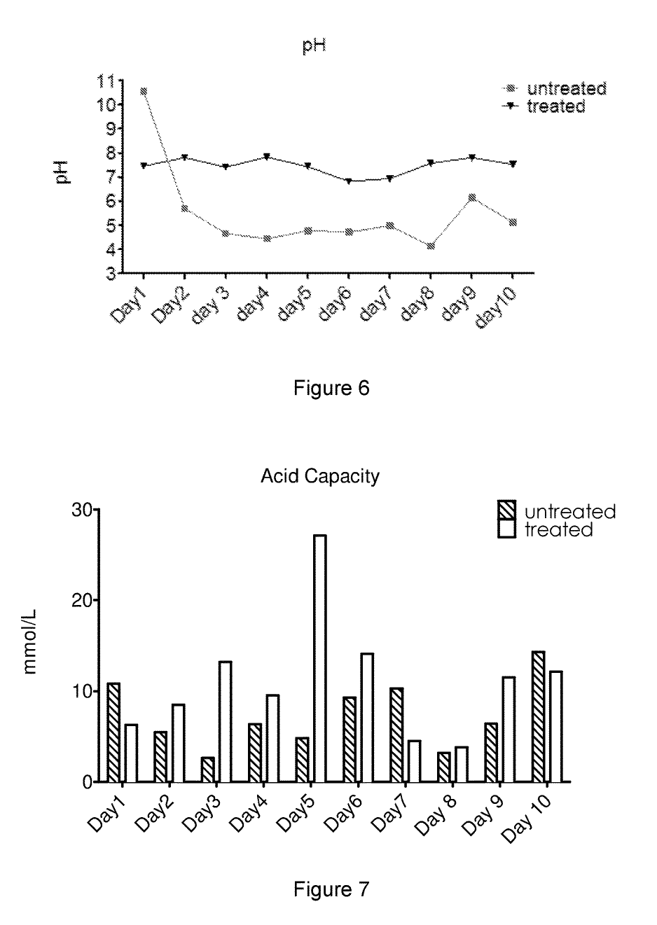

FIG. 6 is a line chart which illustrates pH values in treated water versus untreated water. Winery effluent is characteristically acidic, with a usual pH between 4 and 5. During the harvest period, however some activities in the cellar cause higher pH effluent, such as the effluent used as input water on day 1. The pH was 10.5, and the system neutralised this within 24 hours. Typically acidic cellar effluent was also neutralised consistently on all the other days to a pH between 7.2 and 7.6.

FIG. 7 is a bar chart which illustrates acid capacity in treated water versus untreated water. This important parameter describes the buffering capacity of water. Except for days 1, 7 and 10 the buffering capacity of the treated water was improved.

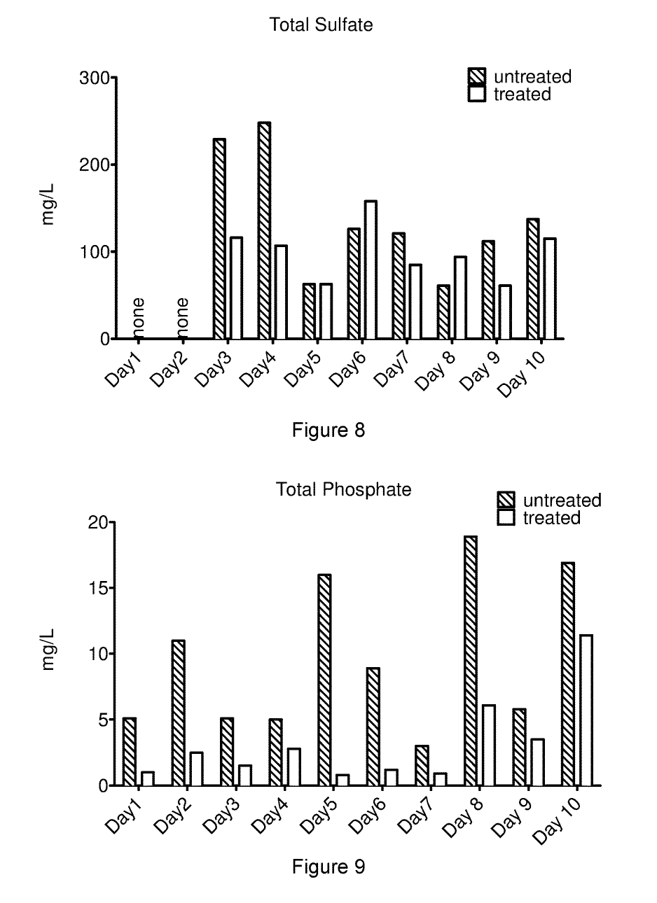

FIG. 8 is a bar chart which illustrates total sulfate in treated versus untreated water. No sulfate was detected in the winery wastewater on days 1 and 2. The sulfate levels in the treated water were improved by a reduction of more than 100 mg/L on days 3 and 4. No improvement was observed on day 5, and the sulfate levels detected in the treated water on day 6 were higher than in the untreated water. This could be ascribed to shed biomass in the sump. Little or no improvement was observed on days 7 to 10.

FIG. 9 is a bar chart which illustrates total phosphate in treated versus untreated water. Phosphate levels were consistently reduced on all 10 days. European Union (EU) requirements for phosphate levels in effluent water are between 0.5 and 1 mg/L. This was achieved by the system on days 1, 5, 6 and 7. It is suspected that phosphate accumulating organisms occur in the biofilm.

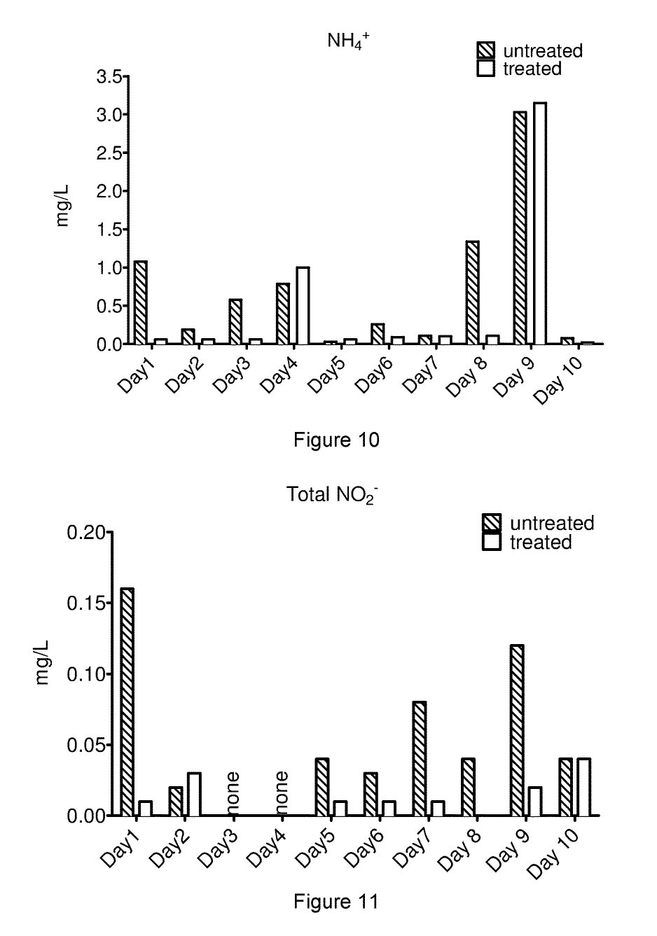

FIG. 10 is a bar chart which illustrates total ammonium ion content of treated versus untreated water. Ammonium ion levels in the untreated winery wastewater varied during the 10 day period. Ammonium ion levels were reduced on all days except days 4 and 9.

FIG. 11 is a bar chart which illustrates total nitrite ion content of treated versus untreated water. The nitrite ion levels in the winery wastewater were low. The presence of nitrite ions in the treated water suggests that nitrification is taking place, and that nitrate containing compounds are being metabolised by the biofilm.

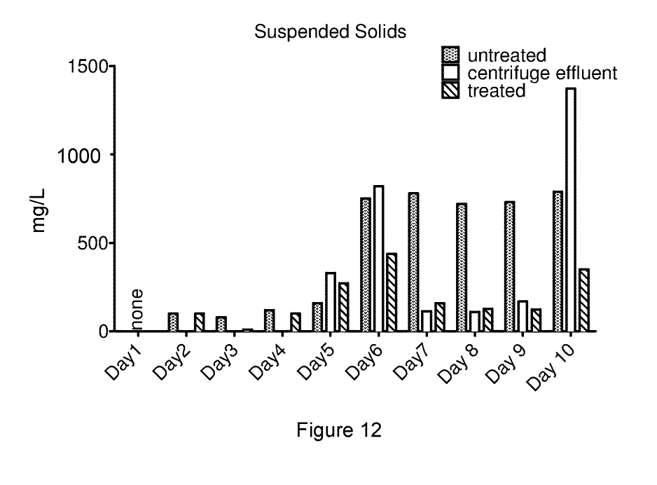

FIG. 12 is a bar chart which illustrates suspended solids in untreated water, centrifuge effluent and treated water. The winery wastewater contained high levels of suspended solids including debris form grape pulp, seeds and stems as well as bentonite clay used in the winery. The centrifuge used in this system is able to remove suspended solids based on a high relative density of the suspended particles. Suspended solids in the winery wastewater on days 1 to 5 was low, but from days 6 to 10, suspended solids were consistently reduced in the treated water. From the data for days 7, 8 and 9, it can be deduced that the biofilm is responsible for the majority of the suspended solid elimination, as the centrifuge effluent contained a comparatively small proportion of suspended solids. On days 6 and 10, however, the suspended solids expelled by the centrifuge surpassed the amount of suspended solids in the untreated water. On day 6 it was speculated that this was due to a shedding of biomass from the biofilm. On day 10, it was visually noticeable that the centrifuge effluent contained large amounts of biofilm biomass, as the liquid was a thick black suspension, resembling the biofilm that developed within the cooling tower. The treated water in the sump of the cooling tower was clear.

Upon investigating the fill media or packing material, it was apparent that most of the biofilm biomass that was present on the fill media on day 9, had detached and washed out of the fill media, confirming results seen in the COD data. A scanning electron microscope (SEM) image taken from a sample at the beginning of day 10 showed that a solid mat of biomass was no longer present, but rather, clumps of biomass. This could have been an indication of the beginning of the biofilm detachment phase.

It will be understood that numerous variations may be made to the embodiments of the invention described above without departing from the scope of the invention.

For example, the packed bed may be provided by any suitable porous fill material such as rocks, Raschig rings, charcoal, a synthetic porous material such as a polypropylene fill media or a specifically designed structured packing such as an arrangement of corrugated sheets each of which typically has inclined corrugations and which are arranged in a cross-corrugated pattern with respect to adjacent sheets.

Embodiments of the invention provide for the tower to be a hollow fiberglass structure, a concrete structure or any other suitable vessel in which the packed bed may be contained. The sump may be integrally formed with tower to define the bottom of the tower. Of course, towers having varying shapes are also anticipated such as tubular, rectangular or the like. The tower may vary in size; accordingly, large scale water filtration systems designed to treat large volumes of contaminated water are anticipated as are small scale water filtration systems. The tower may be a cooling tower.

Any suitable centrifugal separator may be used. The centrifugal separator may have its own pump to pump water through the centrifuge. Similarly, the controllable valves such as the feed water inlet valve and the filtered water outlet valve may be any type of suitable valve controlled in any appropriate manner. The pump may be any suitable pump that is able to provide a sufficient flow rate. For example, for larger water filtration systems, a larger pump may be used to provide a greater flow rate.

More than one biofiltration system may be connected inline or in series in order to increase the capacity for wastewater treatment.

The biofiltration system according to the invention lends itself to a method for filtering wastewater as will be apparent from the above description. In summary, the method includes the steps of creating a biofilm on the packed bed, preferably using the wastewater by allowing it to flow over the packed bed. Then finely dispersed wastewater from a water feed is sprayed over the biofilm on the packed bed, thus allowing the water to run over the biofilm. The water is collected in a sump after flowing over the biofilm on the packed bed and solid material from the water in the sump is separated out using a centrifugal separator. The centrifugal separator expels a waste stream and a filtered water stream. Also water in the sump is typically circulated, optionally together with the filtered water stream from the centrifugal separator, to the water feed until a desired degree of filtration has occurred.

The method includes further steps of sensing the level of water in the sump with a level sensor; periodically feeding water into the sump through a feed water inlet valve and controlling the amount of water that is fed into the sump using a solenoid valve and control unit in communication with the level sensor. Further steps of allowing water to periodically flow out of the sump and controlling the amount of water that flows out of the sump by means of a timer are included in the method. Alternatively, the method includes steps of continuously feeding water into a pipe that connects the sump to the water feed above the packed bed and continuously allowing water to flow out of the pipe at a similar flow rate, provided that the water flows in and out of the pipe downstream of the centrifugal separator and that the water is fed into the pipe downstream of the valve through which water flows out of the pipe.

Throughout the specification and claims unless the contents requires otherwise the word ‘comprise’ or variations such as ‘comprises’ or ‘comprising’ will be understood to imply the inclusion of a stated integer or group of integers but not the exclusion of any other integer or group of integers.

1. A biofiltration system, comprising:
a tower that houses a packed bed on which biofilm is able to form;
a water feed above the packed bed;
a water outlet in a sump below the packed bed,
an air inlet below the packed bed;
an air outlet above the packed bed; and
a centrifugal separator, which is operable to separate solid material from water drawn from the sump to expel a waste stream and a filtered water stream.

2. The biofiltration system as claimed in claim 1, further comprising a pump configured to circulate water from the sump to the water feed.

3. The biofiltration system as claimed in claim 1, wherein the centrifugal separator is configured to run continuously.

4. The biofiltration system as claimed in claim 1, wherein the centrifugal separator is configured to periodically expel a waste stream.

5. The biofiltration system as claimed in claim 4, further comprising a waste outlet of the centrifugal separator, which is fitted with a valve and timer configured to periodically expel the waste stream.

6. The biofiltration system as claimed in claim 1, wherein the centrifugal separator is configured to return filtered water to the sump or to the water feed.

7. The biofiltration system as claimed in claim 1, wherein the air inlet is intermediate the packed bed and the sump.

8. The biofiltration system as claimed in claim 1, wherein the water feed above the packed bed includes nozzles or sprayers configured to finely disperse water over the packed bed.

9. The biofiltration system as claimed in claim 1, wherein the packed bed comprises a highly porous polypropylene fill media.

10. The biofiltration system as claimed in claim 1, wherein the sump comprises a feed water inlet valve configured to periodically feed water to flow into the sump and a filtered water outlet valve configured to periodically allow water to flow out of the sump.

11. The biofiltration system as claimed in claim 10, wherein the feed water inlet valve is controlled by a control unit and level sensor.

12. The biofiltration system as claimed in claim 10, wherein the filtered water outlet valve is controlled by a timer.

13. The biofiltration system as claimed in claim 1, wherein a feed water inlet valve and a filtered water outlet valve are provided along a pipe that connects the sump to the water feed above the packed bed arranged such that both the feed water inlet valve and the filtered water outlet valve are downstream of the centrifugal separator and the feed water inlet valve is downstream of the filtered water outlet valve.

14. The biofiltration system as claimed in claim 13, wherein the feed water inlet valve and filtered water outlet valve are configured to have approximately equal flow rates of water.

15. A method for filtering wastewater, the method comprising:
creating a biofilm on a packed bed in a tower,
finely dispersing wastewater from a water feed over the biofilm,
collecting the water in a sump,
separating solid material from the water in the sump using a centrifugal separator and
expelling a waste stream and a filtered water stream from the centrifugal separator.
